(19) United States
(12) Patent Application Publication
(10) Pub. No.: US 2005/0155857 A1
(43) Pub. Date: Jul. 21, 2005

(54) Sensor element

(76) Inventors: Theodor Graser, Stuttgart (DE); Thomas Wahl, Pforzheim (DE); Hans-Joerg Renz, Leinfelden-Echterdingen (DE); Frank Stanglmeier, Ceske Budejovice (CS); Juergen Sindel, Vaihingen/Enz (DE)

Correspondence Address: KENYON & KENYON, ONE BROADWAY, NEW YORK, NY, 10004, US

(21) Appl. No.: 10/507,536

(22) PCT Filed: Feb. 17, 2003
(86) PCT No.: PCT/DE03/00464

(30) Foreign Application Priority Data
Mar. 13, 2002 (DE) 10210974.5

(51) Int. Cl. G01N 27/26; H01S 4/00

(52) U.S. Cl. 204/424; 204/426; 29/592.1

(57) ABSTRACT

A sensor element constructed in layers for detecting a physical property of a gas or liquid, and in particular for detecting the concentration of a gas component or the temperature of an exhaust gas of an internal combustion engine. The sensor element includes a first and second layer as well as at least one contact face, which is disposed in a layer plane between the first and second layers. In the region of the contact face, the first layer includes a recess.

### FIELD OF INVENTION

The present invention relates to a sensor element.

### BACKGROUND INFORMATION

A sensor element is discussed for instance in German Published Patent Application No. 199 37 163. The planar sensor element includes three ceramic substrate layers. On one measurement end of the sensor element, electrical elements, such as electrodes and a heating element, may be disposed on and between the ceramic substrate layers. The electrical elements may be electrically connected by conductor tracks to contact faces on an end toward the terminals of the sensor element. The contact faces may be disposed on the outside of the sensor element and may be in electrical contact with contact parts that make an electrical connection with an electrical wiring disposed outside the measuring sensor possible.

Both the electrical elements and the corresponding conductor tracks may be disposed at least partially in a layer plane inside the sensor element. To make the electrical connection between the conductor track and the contact face may require throughplating through a ceramic substrate layer. Such throughplating may be complicated from a production standpoint and may involve a not inconsiderable risk of error.

### SUMMARY OF THE INVENTION

A sensor element according to an exemplary embodiment of the present invention may provide simple contacting of the sensor element in production terms economically and with little risk of error. For that purpose, a contact face may be disposed in a layer plane between a first and second layer of the sensor element, and in the region of the contact face, a recess may be provided in the first ceramic layer.

An electrical element, such as an electrode or a heater, disposed inside the sensor element may be connected electrically to the contact face via a conductor track. For contacting the sensor element, a contact part may be disposed inside the recess in the first layer of the sensor element and may in turn be electrically connected to an electrical wiring disposed outside the sensor element. The contact face and the conductor track may be disposed in a layer plane of the sensor element, so that throughplating through a layer of the sensor element may not be required.

The first and second layers may be provided as a ceramic substrate layer whose thickness is in the range from 0.05 mm to 1 mm. A substrate layer is understood hereinafter to be a layer that is suitable as a substrate for printed functional layers (such as an electrode, conductor track, heating element, or ceramic functional layers such as diffusion barriers, or porously filled gas chambers or insulation layers). Producing a sensor element containing such substrate layers should be known to one skilled in the art and therefore sketched only briefly here. The functional layers may be printed by screen printing on a so-called green sheet (a substrate layer in the unsintered state). The printed green sheets may be laminated and then sintered. A substrate layer may also be an unprinted ceramic layer having the above-described properties.

If the recess is shaped in slotlike form, then the contact part may be securely connected electrically to the contact face, since the lateral walls of the slotlike recess may prevent lateral slippage of the contact part. If the slotlike recess is widened toward an outer face of the sensor element, it may become simpler to slip the contact part onto the contact faces of the sensor element (self-centering).

In a sensor element which includes not only the first and second layers but also a further layer, which adjoins the first layer on the side of the first layer remote from the contact face, then the recess may also be provided in the further layer, so that the contact part is also applied to the contact face laterally, that is, in a direction perpendicular to the plane of the contact face.

In an exemplary embodiment of the present invention, the sensor element includes both the first and second layers and a third layer, the layer sequence being in the order given. Both in the layer plane between the first and second layers and in the layer plane between the second and third layers, the sensor element includes contact faces. Recesses may be provided in the region of the contact faces in the first and third layers.

The electrical contact between the contact face and the contact part may be made by a nonpositive and/or positive connection (for instance by soldering or welding, in particular by laser welding). The recess may be made in the green sheet by of the first layer being stamped out, milled or drilled.

### BRIEF DESCRIPTION OF THE DRAWINGS

FIG. 1 shows a perspective view of a portion of a sensor element of a first version of a first exemplary embodiment of the present invention.

FIG. 2 shows a perspective view of a portion of a sensor element of a second version of the first exemplary embodiment of the present invention.

FIG. 3 shows a perspective view of a portion of a sensor element of a third version of the first exemplary embodiment of the present invention.

FIG. 4 is a longitudinal section through a portion of the sensor element taken along the line IV-IV in FIG. 1.

FIG. 5 shows a perspective view of a portion of a sensor element of the present invention in a first version of a second exemplary embodiment.

FIG. 6 shows a perspective view of a portion of a sensor element of the present invention in a second version of the second exemplary embodiment.

### DETAILED DESCRIPTION

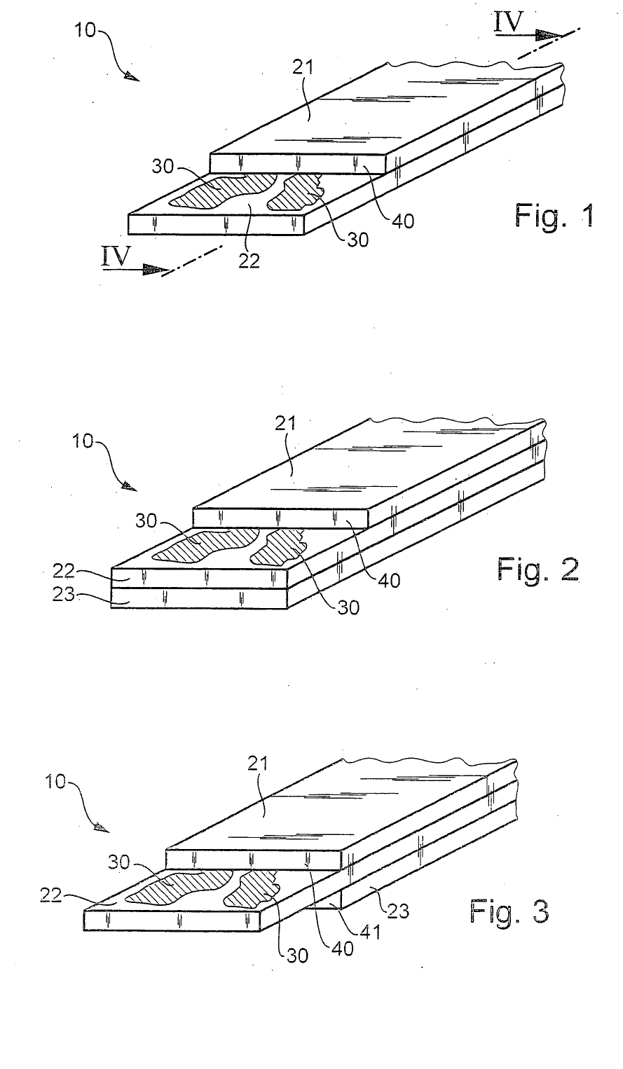

FIGS. 1 and 4, as a first version of a first exemplary embodiment of the present invention, show a terminal end of a sensor element 10. Sensor element 10 includes a first layer 21 and a second layer 22, which are embodied as ceramic substrate layers. In the layer plane between first and second layers 21, 22, two contact faces 30 as well as one conductor track 31 for each contact face 30 are disposed. Conductor track 31 makes an electrical connection between the contact face and an electrical element, which is provided on an end (not shown) of sensor element 10 on the measurement side, remote from the terminal end. First layer 21 forms an outer layer of sensor element 10, since no further substrate layer adjoins the side of first layer 21 remote from second layer 22.

First layer 21, in the region of contact faces 30, includes a recess 40 which extends over the entire width of sensor element 10. The first layer thus extends in the direction of the measurement end of sensor element 10, beginning at the transition from contact face 30 to conductor track 31.

For electrical insulation, a first and second insulation layer 35, 36 are disposed between the conductor track and the respective first and second layers 21, 22. Second insulation layer 36 also extends into the region of contact faces 30, so that contact faces 30 are insulated from second layer 22 by second insulation layer 36. Conversely, first insulation layer 36 is recessed in the region of contact faces 30.

In the other drawing figures the same reference numerals as in sensor element 10 shown in FIG. 1 are used for corresponding elements in the further versions and exemplary embodiments of sensor element 10.

As a second version of the first exemplary embodiment of the present invention, FIG. 2 shows a sensor element 10 which includes an additional third layer 23, which is likewise embodied as a ceramic substrate layer. Third layer 23 covers second layer 22 completely on the side remote from first layer 21. That is, it has no recesses in the region of contact faces 30. Further contact faces may be disposed on the outside of third layer 23, that is, on the side of third layer 23 remote from second layer 22.

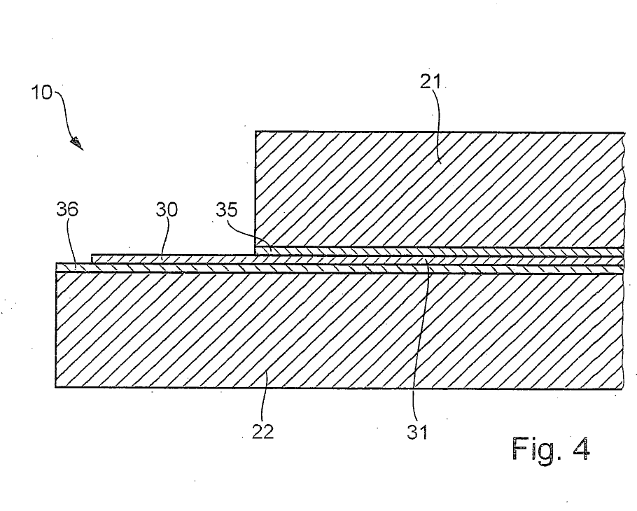

As a third version of the first exemplary embodiment of the present invention, FIG. 3 shows a sensor element 10 which, like the second version, includes an additional third layer 23 that is likewise embodied as a ceramic substrate layer. Here, contact faces 30 are provided on second layer 22, both on the side toward first layer 21 and on the side toward third layer 23. In contrast to the second version, in the third version third layer 23 includes a further recess 41 in the region of contact faces 30.

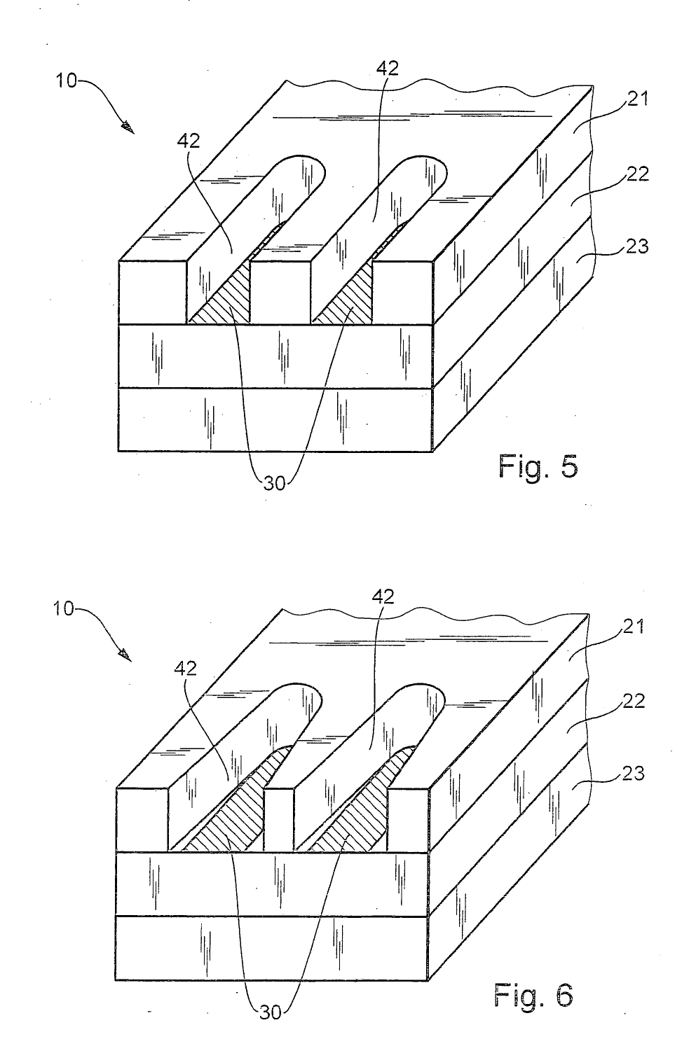

As a first version of a second exemplary embodiment of the present invention, FIG. 5 shows a sensor element 10, which differs from the sensor element shown in FIG. 2 in that one recess 42 of slotlike shape is provided for each of the two contact faces 30. In the second version of the second exemplary embodiment shown in FIG. 6, recesses 42 widen toward the outer face of sensor element 10 that is perpendicular to the longitudinal axis.

First, second and third ceramic layers 21, 22, 23 are substantially of zirconium oxide stabilized with yttrium. Both contact face 30 and conductor track 31 are substantially of platinum with a ceramic supporting framework. The first and second insulation layers contain aluminum oxide as their primary ingredient.

The present invention may also be adopted for other sensor elements, for instance with more than three substrate layers. The recesses may also be made laterally on the sensor element into one or more substrate layers. Moreover, it is possible to provide only one contact face, or more than two contact faces, with the corresponding recesses.

1-12. (canceled)

13. A sensor element for detecting a physical property of one of a gas and a liquid, comprising:
a first layer;
a second layer; and
at least one contact face disposed in a layer plane between the first and second layers, the first layer including a recess in a region of the at least one contact face.

14. The sensor element of claim 1, wherein the sensor element is configured to detect one of a concentration of a gas component and a temperature of an exhaust gas of an internal combustion engine.

15. The sensor element of claim 1, wherein the first and second layers are ceramic substrate layers having a thickness in a range from 0.05 to 1 mm.

16. The sensor element of claim 1, wherein the recess extends in the region of the at least one contact face over an entire width of the sensor element.

17. The sensor element of claim 1, wherein the recess has a slotlike-shaped recess.

18. The sensor element of claim 17, wherein the slotlike-shaped recess widens toward an outer face of the sensor element.

19. The sensor element of claim 1, further comprising:
an electric element and a conductor track arranged inside the sensor element, wherein the at least one contact face is electrically connected to the electrical element via the conductor track.

20. The sensor element of claim 19, wherein the at least one contact face is electrically connected to one of an electrode and a heating element.

21. The sensor element of claim 19, further comprising:
a first electrical insulation layer arranged between the conductor track and the first layer, and including a recess in the region of the at least one contact face; and
a second electrical insulation layer arranged between the conductor track and the second layer, and between the at least one contact face and the second layer.

22. The sensor element of claim 19, further comprising:
a contact part electrically connected to the at least one contact face so that the electrical element, via the conductor track, the at least one contact face, and a contact part, is connected to electrical wiring located outside the sensor element.

23. The sensor element of claim 1, further comprising:
a third layer, wherein there is a further contact face arranged in a layer plane between the second and third layers, and the third layer includes a recess in a region of the further contact face.

24. The sensor element of claim 1, wherein the first layer forms an outer layer of the sensor element.

25. The sensor element of claim 1, further comprising:
at least one further layer which is arranged on a side of the first layer that is remote from the at least one contact face, and which includes an additional recess.

26. A method for producing a sensor element constructed in layers for detecting a physical property of one of a gas and a liquid, the method comprising:
forming a first layer of the sensor element;
forming a second layer of the sensor element, so that at least one contact face is disposed in a layer plane between the first and second layers; and
forming, in the first layer, a recess in a region of the contact face by one of stamping, drilling, and milling the recess in a green body of a ceramic sheet.
